(19) United States
(12) Patent Application Publication
(10) Pub. No.: US 2006/0240205 A1
(43) Pub. Date: Oct. 26, 2006

(54) Method for securement of attachments to molded plastic preforms or containers

(75) Inventor: Thomas B. Garman, Millbury, OH (US)

Correspondence Address: VENABLE LLP, P.O. BOX 34385, WASHINGTON, DC, 20045-9998, US

(73) Assignee: Graham Packaging Plastic Products, Inc., York, PA (US)

(21) Appl. No.: 11/437,632

(22) Filed: May 22, 2006

Related U.S. Application Data
(62) Division of application No. 10/646,245, filed on Aug. 22, 2003.

(51) Int. Cl. B32B 27/08

(52) U.S. Cl. 428/35.7; 428/34.1

(57) ABSTRACT

A method of making a preform assembly includes providing a preform having a closed end, and providing an attachment object having a ring. The attachment object is assembled to the preform by telescoping the ring over the closed end of the preform until the ring is brought into abutting engagement with a portion of the preform in such a way that interference between the ring and the portion of the preform prevents dislodgement or removal of the attachment object during subsequent processing of the preform assembly. The attachment object in the disclosed embodiments of the invention may be a handle, a label or a shroud. The ring on the attachment object may be circumferentially continuous or circumferentially split. Engagement between the attachment object ring and the preform may be by engagement with one or more external protrusions on the surface of the preform, or may be by interference press fit engagement between the ring and the external surface of the preform.

### CROSS-REFERENCE OF RELATED APPLICATION

This application claims priority to U.S. patent application Ser. No. 10/646,245 filed Aug. 22, 2003, the entire contents of which are hereby incorporated by reference.

The present invention is directed to securement of attachment objects, such as handles, to molded plastic preforms and containers, and more particularly to a method of securing such attachment objects, and to preforms and containers having such attachment objects secured thereto.

### BACKGROUND AND SUMMARY OF THE INVENTION

In the manufacture of plastic containers, it is convention to pressure mold a container preform having a body and a finish. (The term “pressure mold” includes compression and injection molding.) The finish typically is molded to its final geometry, while the body of the preform is subsequently blow molded to the desired geometry of the container body. The preform may be of monolayer construction, or may be of multilayer construction in which one or more intermediate layers in the preform body may or may not extend into the finish of the preform. Attachment objects, such as handles, may be secured to the preform or the container by molding the attachment object integrally with the preform or a portion of the preform, or by placing a separately formed attachment object in the blow mold in such a way that the attachment object is secured to the container body during blow molding. It is a general object of the present invention to provide an economical method of securing an attachment object to a hollow plastic preform, and thus ultimately to the blow molded container, and to a preform and a container having such attachment object secured thereto.

The present invention involves a number of aspects that may be implemented separately from or in combination with each other.

A method of making a preform assembly in accordance with a first aspect of the present invention includes providing a preform having a closed end, and providing an attachment object having a ring. The attachment object is assembled to the preform by telescoping the ring over the closed end of the preform until the ring is brought into abutting engagement with a portion of the preform in such a way that interference between the ring and the portion of the preform prevents dislodgement or removal of the attachment object during subsequent processing of the preform assembly. The attachment object in the disclosed embodiments of the invention may be a handle, a label or a shroud. The ring on the attachment object may be circumferentially continuous or circumferentially split. Engagement between the attachment object ring and the preform may be by engagement with one or more external protrusions on the surface of the preform, or may be by interference press fit engagement between the ring and the external surface of the preform.

A method of making a preform assembly for blow molding a container in accordance with another aspect of the invention includes pressure molding a preform having a body and a finish with a flange and a protrusion adjacent to but spaced from the flange. An attachment object is mounted to the preform by providing a ring on the attachment object and moving the ring over the protrusion so that the ring is captured between the protrusion and the flange on the preform finish. When the preform body is subsequently blow molded to form the body of a container, the attachment object is captured between the protrusion and the flange on the container.

In some preferred embodiments of the invention, the attachment ring has an inner diameter that is less than the outer diameter of the protrusion and less than the outer diameter of the flange. The attachment ring preferably is circumferentially expanded by passage over the protrusion, and then received by snap fit between the protrusion and the flange. The outer diameter of the protrusion preferably tapers toward the preform body for resiliently expanding the ring as the ring is received over the protrusion. In some preferred embodiments of the invention, the protrusion is selected from the group consisting of a retention bead and an array of retention gussets.

A finish on a hollow plastic preform or container in accordance with another aspect of the invention includes a radially outwardly projecting circumferential flange, an external protrusion spaced from the flange, and an attachment object that includes an annular ring captured between the protrusion and the flange.

### BRIEF DESCRIPTION OF THE DRAWINGS

The invention, together with additional objects, features, advantages and aspects thereof, will be best understood from the following description, the appended claims and the accompanying drawings, in which:

FIG. 1 is a side elevational view of a preform with handle attachment in accordance with one presently preferred embodiment of the invention;

FIG. 2 is an exploded perspective view of the preform with handle attachment illustrated in FIG. 1;

FIG. 3 is a side elevational view of a plastic container blow molded from the preform and handle attachment of FIG. 1;

FIGS. 4 and 5 are perspective views of respective modified preforms in accordance with the present invention;

FIG. 6 is a perspective view of a preform label attachment in accordance with another embodiment of the invention;

FIG. 7 is a perspective view of a shroud preform attachment in accordance with a further embodiment of the invention;

FIG. 8 is a partially sectioned side elevational view of a preform assembly in accordance with another embodiment of the invention;

FIG. 9 is a perspective view of the attachment handle in the embodiment of FIG. 8;

FIG. 10 is a partially sectioned side elevational view of a preform assembly in accordance with a further embodiment of the invention; and

FIG. 11 is a perspective view of the attachment handle in the embodiment of FIG. 10.

### DETAILED DESCRIPTION OF PREFERRED EMBODIMENTS

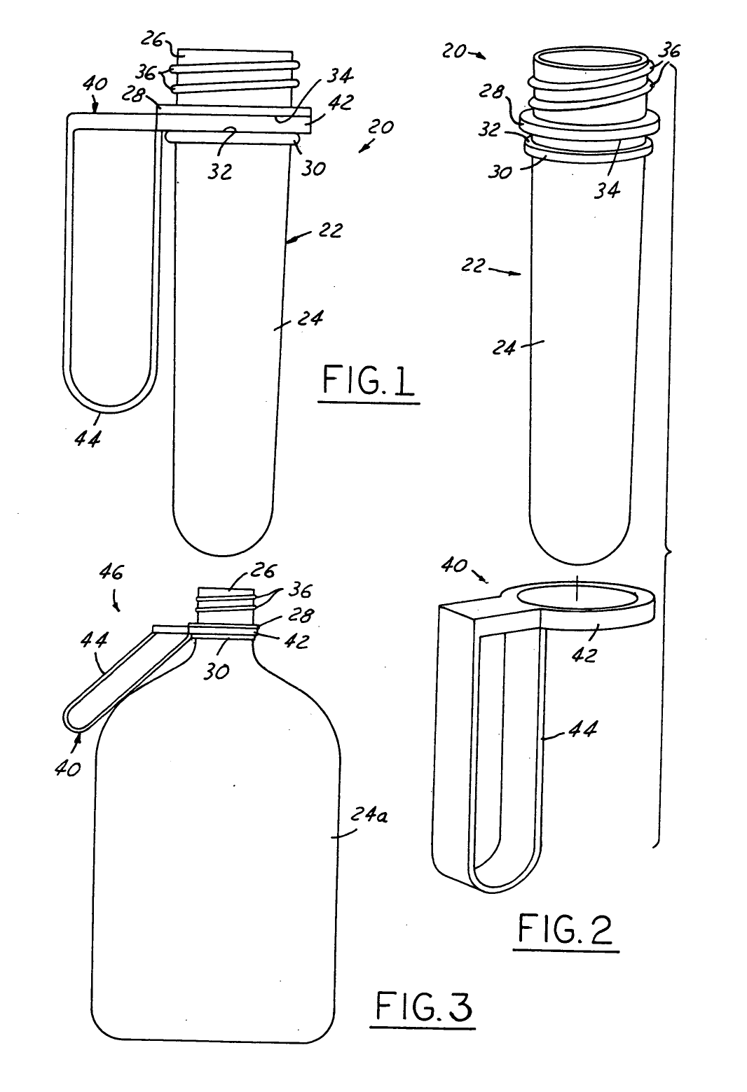

FIGS. 1 and 2 illustrate a preform assembly 20 in accordance with one presently preferred embodiment of the invention. Preform assembly 20 includes a molded plastic preform 22 having a body 24 and an integral finish 26. Finish 26 in this embodiment of the invention preferably includes a radially outwardly projecting circumferential flange 28, sometimes referred to as a capping flange or support flange. An external protrusion 30 is formed on finish 26 during the preform molding operation at a position spaced from flange 28 and disposed between flange 28 and body 24. Protrusion 30, in the embodiment illustrated in FIGS. 1-3, comprises a circumferentially continuous or segmented external annular bead having an upper surface 32 parallel to and spaced from the lower surface 34 of flange 28. (Directional words such as “upper” and “lower” are employed by way of description and not limitation with respect to the upright orientation of the preform and container illustrated in FIGS. 1-3. Directional words such as “radial” and “circumferential” are employed by way of description and not limitation with respect to the central axis of container finish 26, which typically is concentric with the central axis of preform body 24.) Finish 26 typically also includes one or more external threads 36, beads or other suitable means for attaching a closure to the blow molded container. Threads 36 alternatively can be formed in a post-molding operation.

An attachment object 40 is secured to preform 22. Attachment object 40 in the embodiment of FIGS. 1-3 is an attachment handle that includes a circumferentially continuous annular attachment ring 42 and a handle extension 44 extending from ring 42. Handle extension 44 in the illustrated embodiment is a loop-type handle extension, although other handle extensions such as T-shaped handle extensions and bale handle extensions also can be employed. Handle attachment 40 may be constructed of any number of materials including various polymers, metals, papers, composites or combinations thereof. Handle attachment 40 preferably is of one-piece integrally molded plastic construction. Ring 42 has an inside diameter that is less than the outside diameter of bead 30 on preform 22, and less than the outside diameter of preform flange 28. After preform 22 is molded, attachment handle 40 is secured thereto by telescoping ring 42 over the closed end of preform body 24, and then over bead 30 by circumferential elastic expansion of ring 42. When ring 42 clears bead 30, ring 42 contracts and is received by snap fit between bead 30 and flange 28. The thickness of ring 42 is slightly less than the axial spacing between bead surface 32 and flange surface 34 so that ring 42 is snugly received between the flange and bead. Preform assembly 20 is then placed in a blow mold, and preform body 24 is blown to the contour 24a of a container 46 (FIG. 3). This blow molding operation does not affect finish 26, including flange 28 and bead 30, so that attachment ring 42 of handle 40 remains retained between flange 28 and bead 32 and forms part of container assembly 46.

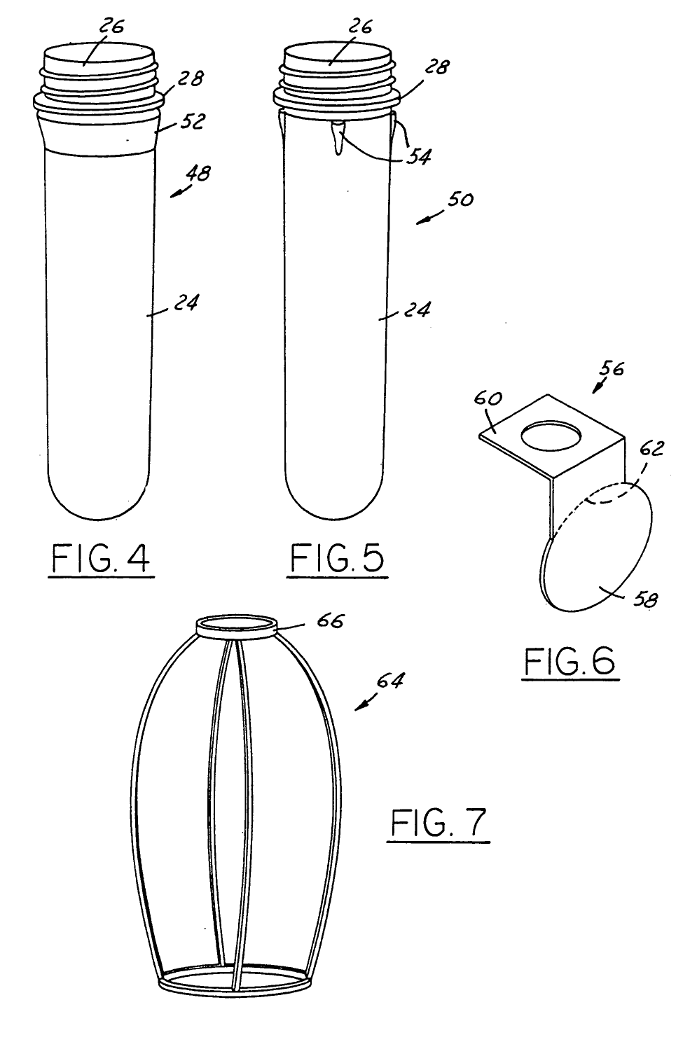

FIGS. 4 and 5 illustrate two alternative preforms 48, 50 in accordance with modified embodiments of the invention. In preform 48 of FIG. 4, the attachment-retention protrusion 52 is in the form of an external shoulder or bead having a conical outer surface that narrows toward body 24 of preform 48. This conical surface helps expand attachment ring 42 (FIG. 2) during assembly to preform 48. In preform 50 of FIG. 5, the ring-expanding protrusion is in the form of a circumferential array of tapering external gussets 54 disposed around the outer surface of preform 50. Gussets 54 have outer surfaces that taper toward preform body 24. In both FIGS. 4 and 5, the retention elements 52, 54 have upper surfaces that are spaced from preform flange 28 as previously described.

FIG. 6 illustrates a modified embodiment of the invention, in which the attachment object 56 to be secured to the preform includes a label 58 secured to an expansible attachment ring 60. Label attachment 56 may be secured to the preform as previously described and then, when placed in the blow mold, oriented at a desired position with respect to the blow mold cavity so that label 58 appears at a desired position on the body of the container. Label 58 will be an integral part of the blow molded container sidewall, and attachment ring 60 may be removed from the label by separation along serrations 62.

FIG. 7 illustrates a shroud or jacket 64 that may be attached to the preform prior to blow molding. Shroud 64 includes an annular attachment ring 66 that is received by snap fit on the preform as previously described. Shroud 64 becomes a permanent part of the container body as a result of blow molding the container body.

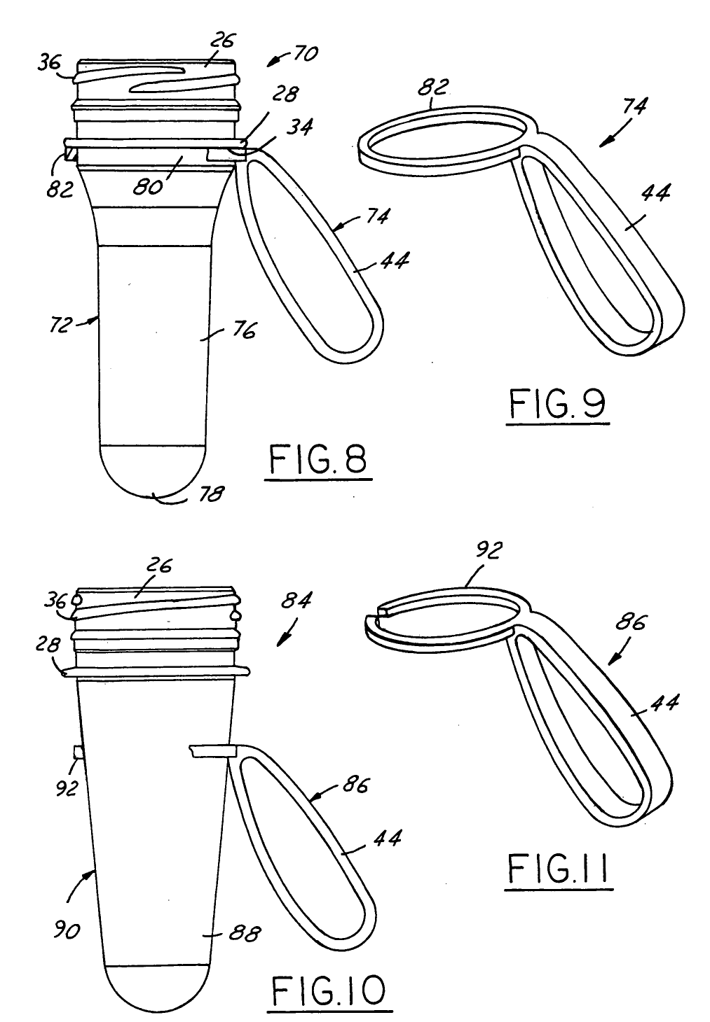

FIGS. 8 and 9 illustrate a preform assembly 70 in accordance with a further embodiment of the invention. Assembly 70 includes a preform 72 and an attachment object 74 in the form of an attachment handle. Preform 72 includes a body 76 having a closed end 78 and a finish 26 with a support flange 28. Preform body 76 includes a portion 80 immediately beneath support flange 28 having a substantially cylindrical outer surface. Handle attachment 74 includes a circumferentially continuous ring 82 received by interference press fit over preform surface 80. That is, the inside diameter of attachment ring 82 preferably is such as compared with the outside diameter of preform surface 80 that ring 82 will be in press-fit engagement over surface 80 under all tolerance conditions.

FIGS. 10 and 11 illustrate a preform assembly 84 in accordance with another embodiment of the invention. In this embodiment, the attachment object, specifically an attachment handle 86, is assembled to the body 88 of preform 90 by being received by press fit over the tapering conical outer surface of body 88. In other words, handle attachment 86, which has a circumferentially split attachment ring 92 in this embodiment, is press fitted over the tapering outer surface of preform body 88. Thus, the embodiments of FIGS. 8-9 and 10-11 employ interference press fit for retention of the attachment object to the preform, rather than interference with retention features molded on the external surface of the preform. It will be appreciated, of course, that attachment handle 86 in FIG. 11 could be provided with a circumferentially continuous attachment ring, and that the attachment objects illustrated in FIGS. 1-9 could be provided with circumferentially split attachment rings. Likewise, attachment shrouds or labels could be employed in the embodiments of FIGS. 8-11.

The preform geometries illustrated in FIGS. 1-2, 4-5, 8 and 10, and the container geometry illustrated in FIG. 3, are intended to be general or generic, and not as limiting features of the invention. The preform and/or container geometry may be of any desired shape. Likewise, the geometry of the preform and container finish above flange 28 is not germane to the present invention, with closure attachment threads 36 being shown by way of example. Other closure attachment means, such as retention beads, may be employed. Indeed, the closure attachment portion of the finish may be separately formed and secured to the preform after molding the preform, or may be secured to the container after blow molding the container body.

There have thus been disclosed a method of making a preform assembly, a method of making a container, and a finish for a preform or container that fully satisfy all of the objects and aims previously set forth. The invention has been disclosed in conjunction with a number of presently preferred embodiments, and a number of modifications and variations have been discussed. Other modifications and variations will readily suggest themselves to persons of ordinary skill in the art. The invention is intended to embrace all such modifications and variations as fall within the spirit and broad scope of the appended claims.

1. A method of making a preform assembly, which includes the steps of:
(a) providing a preform having a closed end,
(b) providing an attachment object having a ring, and
(c) assembling said attachment object to said preform by telescoping said ring over said closed end until said ring is brought into abutting engagement with a portion of said preform in such a way that interference between said ring and said portion of said preform prevents dislodgement or removal of said attachment object during subsequent processing of the preform assembly.

2. The method set forth in claim 1 wherein said ring is circumferentially continuous or circumferentially split.

3. The method set forth in claim 1 wherein said step (c) is carried out by interference press fit between said ring and said preform.

4. The method set forth in claim 3 wherein said preform has an angulated surface portion, and said ring is press fit onto said angulated surface portion of said body.

5. The method set forth in claim 3 wherein said body has a cylindrical portion and said ring is press fit onto said cylindrical portion.

6. The method set forth in claim 1 wherein said step (b) is carried out by securing said ring over one or more external retention features on said preform.

7. The method set forth in claim 6 wherein said step (a) includes pressure molding a preform having at least one integrally molded external retention feature, and wherein said step (b) is carried out by telescopically fitting said ring over said closed end and over said retention feature.

8. A method of making a preform assembly for blow molding a container, which includes the steps of:
(a) pressure molding a preform having a body and a finish with a flange and a protrusion adjacent to and spaced from said flange,
(b) providing an attachment object having a ring, and
(c) mounting said attachment object to said preform by moving said ring over said protrusion so that said ring is captured between said protrusion and said flange.

9. The method set forth in claim 8 wherein said ring has an inner diameter that is less than the outer diameter of said protrusion, and wherein said step (c) includes resiliently expanding said ring by passage over said protrusion such that said ring is received by snap fit between said protrusion and said flange.

10. The method set forth in claim 9 wherein said outer diameter of said protrusion tapers toward said preform body for resiliently expanding said ring as said ring is received over said protrusion.

11. The method set forth in claim 9 wherein said protrusion is selected from the group consisting of a retention bead and an array of retention gussets.

12. The method set forth in claim 9 wherein said attachment object is selected from the group consisting of a handle, a label and a shroud.

13. The method set forth in claim 9 including the step of: (d) blow molding said preform body to form a container to which said attachment object is secured.

14. A method of making a preform assembly for blow molding a container, which includes the steps of:
(a) providing a preform having a body with a closed end,
(b) providing an attachment object having a ring, and
(c) mounting said attachment object to said preform by moving said ring over said closed end and bringing said ring into interference press fit with an outer surface of said preform.

15. The method set forth in claim 14 wherein said preform has a portion with a tapering outer surface, and wherein said step (c) includes bringing said ring into interference fit with said tapering outer surface.

16. The method set forth in claim 14 wherein said preform has a portion with a cylindrical outer surface, and wherein said step (c) includes bringing said ring into interference fit with said cylindrical outer surface.

17. The method set forth in claim 14 wherein said ring is circumferentially continuous or circumferentially split.

18. A method of blow molding a hollow plastic container with attached object, which includes the steps of:
(a) pressure molding a preform having a body and a finish with a flange and a protrusion adjacent to and spaced from said flange,
(b) providing an attachment object having a ring,
(c) mounting said attachment object to said preform by moving said ring over said protrusion so that said ring is captured between said protrusion and said capping flange, and
(d) blow molding said preform body to form a container having said attachment object attached thereto.

19. The method set forth in claim 18 wherein said ring has an inner diameter that is less than the outer diameter of said protrusion, and wherein said step (c) includes resiliently expanding said ring by passage over said protrusion such that said ring is received by snap fit between said protrusion and said flange.

20. The method set forth in claim 19 wherein said outer diameter of said protrusion tapers toward said preform body for resiliently expanding said ring as said ring is received over said protrusion.

21. The method set forth in claim 19 wherein said protrusion is selected from the group consisting of a retention bead and an array of retention gussets.

22. A preform assembly for blow molding a hollow plastic container and constructed in accordance with the method set forth in claim 9.

23. A blow molded hollow plastic container constructed in accordance with the method set forth in claim 19.

24. (canceled)

25. (canceled)

26. (canceled)

27. (canceled)

28. (canceled)

29. (canceled)

30. (canceled)
